(19) United States
(12) Patent Application Publication
(10) Pub. No.: US 2009/0048824 A1
(43) Pub. Date: Feb. 19, 2009

(54) ACOUSTIC SIGNAL PROCESSING METHOD AND APPARATUS

(75) Inventor: Tadashi Amada, Yokohama-shi (JP)

Correspondence Address: Charles N.J. Ruggiero, Esq.;Ohlandt, Greeley, Ruggiero & Perle, L.L.P., One Landmark Square, 10th Floor, Stamford, CT, 06901-2682, US

(73) Assignee: KABUSHIKI KAISHA TOSHIBA

(21) Appl. No.: 12/192,670

(22) Filed: Aug. 15, 2008

(30) Foreign Application Priority Data
Aug. 16, 2007 (JP) 2007-212304

(51) Int. Cl. G06F 17/21

(52) U.S. Cl. 704/10

(57) ABSTRACT

An audible signal process method includes preparing, in at least one dictionary, a plurality of weighting factors each learned to optimize evaluation function established by a weighted learning audible signal and a target speech signal corresponding to the learning audible signal and used for weighting, estimating a noise component included in the input audible signal, calculating a feature quantity depending upon the noise component of the input audible signal, selecting a weighting factor corresponding to the feature quantity from the dictionary, and weighting the input audible signal using the selected weighting factor to generate a processed output audible signal.

### CROSS-REFERENCE TO RELATED APPLICATIONS

This application is based upon and claims the benefit of priority from prior Japanese Patent Application No. 2007-212304, filed Aug. 16, 2007, the entire contents of which are incorporated herein by reference.

### BACKGROUND OF THE INVENTION

1. Field of the Invention

The present invention relates to an audio signal processing method for suppressing a noise component in an input audio signal and an apparatus for the same.

2. Description of the Related Art

When a speaker speaks over the phone with a cellular phone or a cordless phone, the ambient noise mixed in the voice of the speaker disturbs speaking. Also, when a speech recognition technology is used in an actual environment, the ambient noise becomes a factor to degrade recognition accuracy. A noise canceller is often used as one of methods for solving such a problem of noise.

The Minimum Mean-Square Error (MMES) method is disclosed by Y. Ephraim, D. Malah, “Speech Enhancement Using a Minimum Mean-Square Error Short-Time Spectral Amplitude Estimator”, IEEE Trans. ASSP vol. 32, 1109-1121, 1984 and Y. Ephraim, D. Malah, “Speech Enhancement Using a Minimum Mean-Square Error Log-Spectral Amplitude Estimator”, IEEE Trans. ASSP vol. 33, 443-445, 1985. This method has a high quality of noise suppression and a high subjective estimation value in a noise canceller, and a method used as a superior method well organized broadly.

The MMSE method obtains an estimate value of a target speech signal by multiplying each frequency component of the input audible signal from a microphone by a weighting factor. In order for the weighting factor to be determined, a method is used wherein the target speech signal and noise component contained in the input audible signal are assumed to accord to independent Gaussian distributions, respectively, and an analytical weighting factor is obtained.

On one hand, R. Zelinski, “A Microphone Array with Adaptive Post-filtering for Noise Reduction,” IEEE ICASSP88 pp. 2578-2581, 1988 is quoted as a noise suppression technology with use of a plurality of microphones. This document discloses a method of performing noise suppression effectively by comprising a Wiener filter using a cross spectrum between channels.

A method of obtaining a weighting factor statistically by applying a statistical model such as a Gaussian distribution to a target speech signal and a noise component has a problem that complicated functional calculus needs and a calculation amount increases. Actually, it is not always true that the target speech signal and the noise component accord to the statistical model supposed beforehand such as the Gaussian distribution. When the target speech signal and noise component dissociate from a statistical model largely, the obtained weighting factor is not appropriate, resulting in falling noise suppression performance.

The present invention is directed to providing an acoustic signal processing method and apparatus capable of realizing a high noise suppression effect by generating an appropriate weighting factor without complicated calculation.

### BRIEF SUMMARY OF THE INVENTION

An aspect of the present invention provides an audible signal process method includes: preparing, in at least one dictionary, a weighting factor learned to optimize evaluation function established by an weighted learning audible signal and a target speech signal corresponding to the learning audible signal and used for weighting; estimating a noise component included in the input audible signal; calculating a feature quantity depending upon the noise component of the input audible signal; selecting a weighting factor corresponding to the feature quantity from the dictionary; and weighting the input audible signal using the selected weighting factor to generate a processed output audible signal.

### BRIEF DESCRIPTION OF THE SEVERAL VIEWS OF THE DRAWING

FIG. 1 is a block diagram of an acoustic signal processing apparatus of the first embodiment.

FIG. 2 is a flow chart, illustrating a processing procedure in the first embodiment.

FIG. 3 is a block diagram of an acoustic signal processing apparatus of the second embodiment.

FIG. 4 is a block diagram of an acoustic signal processing unit of the third embodiment.

FIG. 5 is a block diagram of an acoustic signal processing unit of the fourth embodiment.

FIG. 6 is a block diagram of an acoustic signal processing unit of the fifth embodiment.

FIG. 7 is a block diagram of an acoustic signal processing apparatus of the sixth embodiment.

FIG. 8 is a block diagram of an acoustic signal processing apparatus of the seventh embodiment.

FIG. 9 is a block diagram of an acoustic signal processing apparatus of the eighth embodiment.

FIG. 10 is a flow chart illustrating a processing procedure of the eighth embodiment.

FIG. 11 is a block diagram of an acoustic signal processing apparatus of the ninth embodiment.

FIG. 12 is a block diagram of an acoustic signal processing apparatus of the tenth embodiment.

FIG. 13 is a diagram illustrating contents of a representative point dictionary shown in FIG. 12.

FIG. 14 is a flow chart illustrating a processing procedure of the tenth embodiment.

FIG. 15 is a block diagram of an acoustic signal processing apparatus of the eleventh embodiment.

### DETAILED DESCRIPTION OF THE INVENTION

There will be explained embodiments of the present invention hereinafter.

### First Embodiment

As shown in FIG. 1, in the audible signal processing apparatus according to the first embodiment, input acoustic signals of N channels from a plurality of (N) microphones 101-1 to 101-N are input to a feature quantity calculator 102 and weighting units 105-1 to 105-N. The feature quantity calculator 102 calculates a feature quantity of each input audible signal by a process including evaluation of a noise component included in the input audible signal. The weighting factor dictionary 103 stores a number of weighting factors obtained beforehand by learning done by a learning unit 100.

A selector 104 selects a weighting factor corresponding to the feature quantity calculated with the feature quantity calculator 102 from the weighting factor dictionary 103. The weighting units 105-1 to 105-N each generate an output sound signal wherein a noise is suppressed by multiplying the input audible signals by the weighting factors selected by the selector 104.

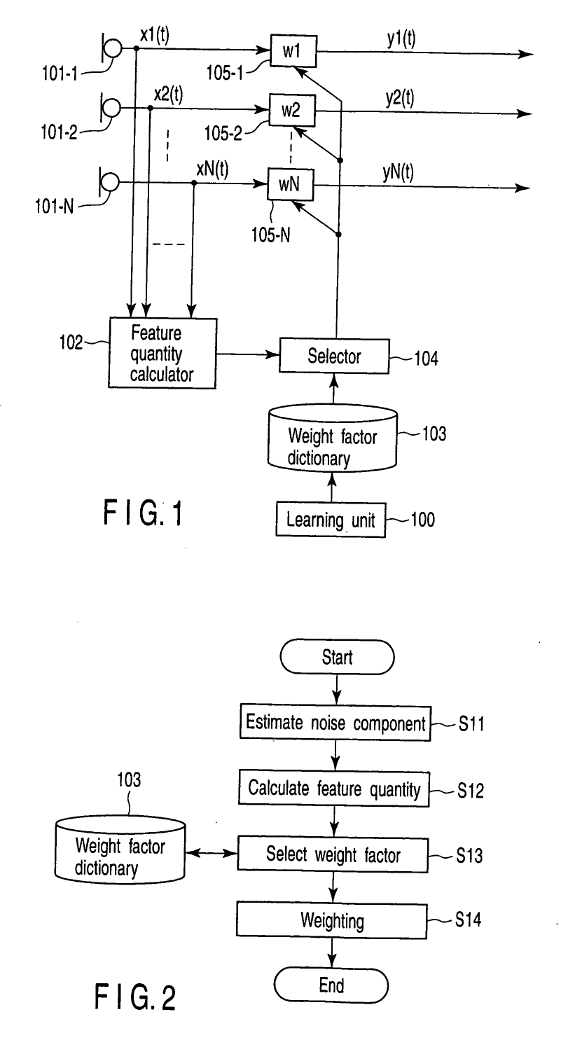

The processing procedure of the present embodiment is described with reference to a flow chart of FIG. 2. The electrical signals output by the microphones 101-1 to N, i.e., input audible signals x1(t) to xN(t) (N is not less than 1) are input to the feature quantity calculator 102. The feature quantity calculator 102 estimates noise components included in the input audible signals x1(t) to xN(t) (step S11), and calculates feature quantities of the input audible signals x1(t) to xN(t) depending upon the noise components (step S12). There is a signal-noise ratio (SNR) calculated by the following equation for an example of such a feature quantity.

$$S N R n ( t ) = \frac{SGn ( t )}{NSn ( t )} \qquad ( 1 )$$

where SG and NS indicate powers of the signal component of the input audible signal and the noise component respectively, n indicates the channel number (the number of each of microphones 101-1 to 101-N), and t is a time.

The estimation of noise component is usually done using the input audible signal in an interval during which there is no desired signal component (target speech signal). SNRn(t) of the equation (1) may be updated sequentially or may be averaged during a certain time width.

Next, the selector 104 selects the weighting factor corresponding to SNR n(t) from the weighting factor dictionary 103 with (step S13). The weighting factor dictionary 103 stores weighting factors learned for each SNR n(t) beforehand. The learning will be explained in detail later.

At the last, the weighting unit 105 multiplies the input audible signals x1(t) to xN(t) by the weighting factors selected with the selector 104 to generate output audible signals y1(t) to yN(t) in which noise is suppressed (step S14).

The weighting factor dictionary 103 may prepare the weighting factor for each channel independently, and may be common between the channels. When the microphones 101-1 to 101-N are adjacent to each other, if the weighting factor is brought in common between the channels, the capacity of a memory used for the weighting factor dictionary 103 can be reduced without slowing down the performance.

The feature quantity calculator 102 may calculate the feature quantity for each channel independently. However, it is effective to reduce statistical dispersion by averaging the powers of the signal components and noise components of the input audible signals x1(t) to xN(t). Also, the configuration of the feature quantity can be modified diversely. For example, it is possible to obtain a feature quantity for each channel independently and then to obtain a vector using each feature quantity as a factor to make multi-dimensional features.

When the weighting units 105-1 to 105-N carry out filtering in time domain, output audible signals y1(t) to yN(t)=yn(t) are expressed by the following equation as a convolution of a weighting factor wn and the input audible signals x1(t) to xN(t)=xn(t).

$$yn ( t ) = {\sum }_{k = 0}^{L - 1} ( xn ( t - k ) \times wn ( k ) ) \qquad ( 2 )$$

where the weighting factors are expressed by wn={wn(0), wn(1), . . . , wn(L−1)}. L is a filter length.

By selecting a weighting factor to be used for weighting from the weighting factor dictionary 103 provided by pre-learning, based on the feature quantity of the input audible signal, the present embodiment can improve noise suppression performance more effectively in comparison with a technique to use a general statistical model in the case of the environment such as a car interior where a kind of noise is limited. In this case, it is an important point how the pre-learning is done by a learning unit 100. The learning method will be described by the following embodiment in detail.

### Second Embodiment

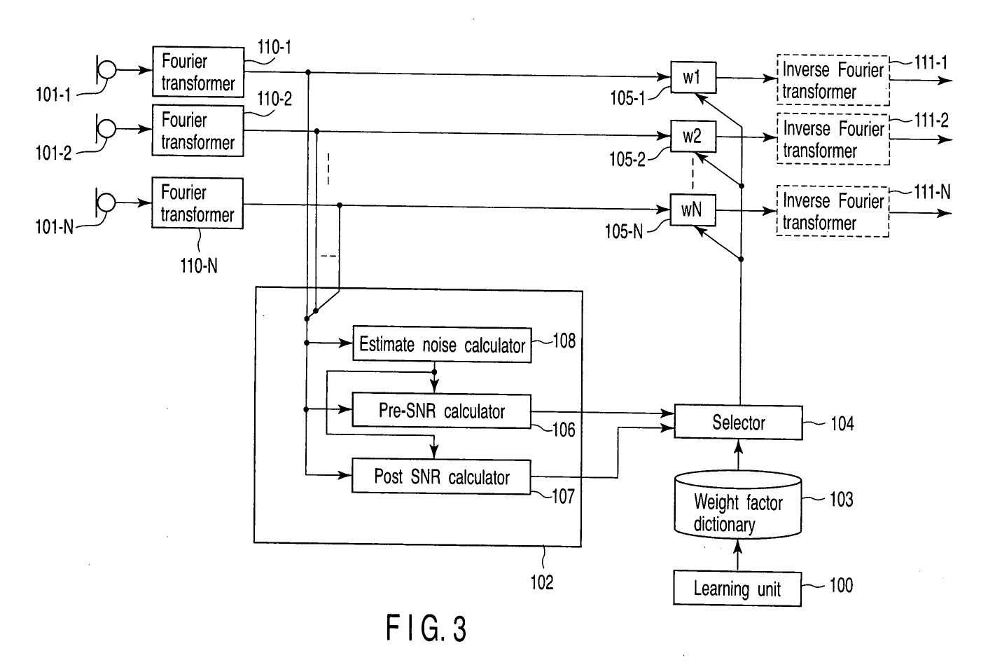

In the audible signal processing apparatus related to the second embodiment shown in FIG. 3, the input audible signals from the microphones 101-1 to 110-N (N is not less than 1) are input to Fourier transformers 110-1 to 110-N to be transformed from a signal of time domain to a signal of frequency domain.

The feature quantity calculator 102 comprises an estimate noise calculator 108 for estimating a noise component in the input audible signal from an output signal of each of Fourier transformers 110-1 to 110-N, a pre-SNR calculator 106 for calculating a pre-SNR of the input audible signal, and a post SNR calculator 107 for calculating a post SNR of the input audible signal. The calculated pre-SNR and post SNR are supplied to the selector 104 used for selecting a weighting factor from the weighting factor dictionary 103.

The weighting units 105-1 to 105-N weight output signals from the Fourier transformers 110-1 to 110-N by the weighting factors selected with the selector 104. The inverse Fourier transformers 111-1 to 111-N transform the weighted signals into output audible signals of time domain.

The principle of operation of the present embodiment will be described hereinafter. The Fourier transformer 110-N converts the input audible signal xn(t) from the N-th microphone 101-N to a frequency component Yn(l,k), where l indicates the frame number, and k indicates the frequency number. The Fourier transform is usually done for each given frame length (L samples), to provide k frequency components. Actually, since approximately half of the k frequency components are symmetric components, it is general to process the signal except for them. If signals transformed into frequency domain are input as the input audible signals, the Fourier transformers 110-1 to 110-N are unnecessary. In the following explanation, the channel number n is omitted and Yn(l,k) is recited as Y(l,k).

In the present embodiment, when the input audible signal Y(l,k) is expressed as the sum of a target speech signal X(l,k) and a noise component N(l,k) as shown by the following equation, an estimate value X′(l,k) of the target speech signal is obtained.

Y(l, k)=X(l, k)+N(l, k) (3)

The estimate noise calculator 108 estimates a statistical characteristic, for example, an average of noise power (referred to as an estimate noise power) as the simplest example. There are various methods as a calculation method for the estimate noise power. For example, there is a method of detecting a noise interval and obtaining an average power during the detected noise interval. As other methods are discussed various methods as described in detail in Rainer Martin, “Noise power spectral density estimation based on optimal smoothing and minimum statistics, “IEEE Transactions on speech and audio processing, vol. 9, No. 5, pp. 504-512, July 2001, or documents listed in this document.

The operation of the post SNR calculator 107 will be described. The post SNR is defined by the ratio between the power of the input audible signal and the power of the noise component. This is assumed to be expressed by the following equation.

$$γ ( l , k ) = \frac{{R}^{2} ( l , k )}{λ d ( l , k )} \qquad ( 4 )$$

where R2(l,k) and λd(l,k) indicate the power of the input audible signal of the k-th band of the first frame (square of an amplitude spectrum) and the power of the estimate noise component respectively.

The operation of the pre-SNR calculator 106 will be described hereinafter. The pre-SNR is defined by the ratio between the power of the target speech signal included in the input audible signal and the power of the noise component. Since the target speech signal cannot be directly observed, an estimate value of pre-SNR is obtained. The calculation method according to the following equation mentioned in Y. Ephraim, D. Malah, “Speech Enhancement Using a Minimum Mean-Square Error Short-Time Spectral Amplitude Estimator”, IEEE Trans. ASSP vol. 32, 1109-1121, 1984 is cited as a representative calculation method of pre-SNR.

ξ′(l, k)=αγ(l−1,k)G(l−1,k)²+(1−α)P[γ(l,k)−1] (5)

where G(l−1,k) indicates a weighting factor before a frame, a indicates a smoothing coefficient, P[ ] represents a calculation that if a value between [ ] is negative, it is replaced by 0. As the calculation method of pre-SNR, various modifications such as a method of using P[γ(l,k)−1] itself in the equation (5) or a method of changing α in the equation (5) adaptively are conceivable.

The above mentioned pre-SNR and post SNR are expressed in form of signal-to-noise ratio, but the denominator and molecule can treated independently. For example, there is a method that if the SNR is a post SNR, it is expressed by a two-dimension vector (R2(l,k), λd(l,k)) that uses the denominator and molecule of the equation (4) as factors, or a method that if it is a pre-SNR, it is expressed by a two-dimension vector that uses the molecule and denominator of the equation (5) as factors. A method of using one part of these factors (the total three-dimension of the first factor of the pre-SNR and the post SNR, etc.) is possible. Further, it is possible to include the SNR of the input audible signal of another channel, or to compose one feature quantity by SNR of input audible signals of all channels and share one feature quantity between the input audible signals of all channels.

The operation of the selector 104 will be described hereinafter. The selector 104 selects a weighting factor corresponding to the pre-SNR ξ(l,k) and post SNR γ(l,k) input from the feature quantity calculator 102, namely the feature quantity f(l,k)=(ξ(l,k), γ(l,k)) from the weighting factor dictionary 103 which stores a number of weighting factors learned beforehand.

For the method of corresponding the feature quantity f (l,k)=(ξ(l,k), γ(l,k)) to the weighting factor W(l,k) in the weighting factor dictionary 103, a method of preparing for a plurality of representative feature quantities (representative points) and a weighting factor corresponding to each feature quantity beforehand, selecting a representative vector which is nearest to the input feature quantity and outputting a weighting factor corresponding to this representative vector is simple and easy. More generally, the correspondence between the feature quantity f(l,k)=(ξ(l,k), γ(l,k)) and the weighting factor W(l,k) using a function F assuming the feature quantity as an input is expressed as follows:

W(l,k)=F(ξ(l,k),γ(l,k)) (6)

At the last, the weighting unit 105 multiplies an input spectrum, that is, a signal of frequency domain from the Fourier transformers 110-1 to 110-N by the weighting factor to obtain an estimate value of a target speech signal.

X′(l,k)=W(l,k)Y(l,k) (7)

The signal of the equation (7) is inverse-transformed by the inverse transformers 111-1 to 111-N as needed to produce a signal of time domain.

Alternatively, it can use expression of time domain equal to the inverse transform of the equation (7).

x′(t)=W(t)*y(t) (8)

where * expresses convolution shown in the equation (2). This can be realized as a filtering process of time domain.

With Y. Ephraim, D. Malah, “Speech Enhancement Using a Minimum Mean-Square Error Short-Time Spectral Amplitude Estimator”, IEEE Trans. ASSP vol. 32, 1109-1121, 1984 and Y. Ephraim, D. Malah, “Speech Enhancement Using a Minimum Mean-Square Error Log-Spectral Amplitude Estimator”, IEEE Trans. ASSP vol. 33, 443-445, 1985, the target speech signal and noise component are assumed to accord to a Gaussian distribution, and the weighting factor W(l,k) is obtained in analytical form. When the audible signal treated really indicates a statistical property to be almost this hypothesis, the method disclosed by Y. Ephraim, D. Malah, “Speech Enhancement Using a Minimum Mean-Square Error Short-Time Spectral Amplitude Estimator”, IEEE Trans. ASSP vol. 32, 1109-1121, 1984 and Y. Ephraim, D. Malah, “Speech Enhancement Using a Minimum Mean-Square Error Log-Spectral Amplitude Estimator”, IEEE Trans. ASSP vol. 33, 443-445, 1985 are effective, but an actual audible signal does not always accord to a Gaussian distribution. A study to apply Rabulas distribution and gamma distribution is considered. However, there are problems that calculation is complicated, and it cannot but compromise with an approximate solution. Further, the actual audible signals take often more complicated distribution in comparison with these distributions. In many cases, the premise itself to suppose a statistical model becomes a problem.

In the present embodiment, in order for this problem to be solved, the following method is used. In other words, it does not suppose a statistical model, but learns the function F( ) of the equation (6) beforehand by using a signal near to the target speech signal and noise component which are used actually, and determines a weighting factor according to the function F( ) in actual use of the audible signal processor. As a result, this method is limited to environment similar to that in learning, but provides an effect that good performance is provided in the condition. For example, when the audible signal processing apparatus is used by being mounted on a car, it is possible to realize good noise suppression performance at the time of running by learning beforehand using a running noise

Another advantage of the present embodiment is a point to need not calculate the weighting factor using a complicated calculation equation, because the weighting factor stored in the weighting factor dictionary 103 is referred to on the basis of the feature quantity of the input audible signal. It is possible by the prior method to solve the problem by a method of calculating the weighting factor beforehand by discrete values (in units of 1 dB) of the pre-SNR and post SNR, and preparing as table data of weighting factors. However, the present embodiment provides a method of setting table data of the weighting factor to a value suitable to the environment where the audible signal processing apparatus is really used.

A method of learning a weighting factor according to the present embodiment will be described hereinafter. At first, a learning audible signal is prepared as an input audible signal, and a target speech signal is prepared as an ideal output speech signal. For example, when only a speech signal from an audible signal mixed with noise is emphasized, the learning audible signal is a speech signal on which noise is superposed, and the target speech signal is a signal including only a speech. In many cases, these signals are generated by adding the noise component and speech signal with a computer, or by using only a speech signal.

Subsequently, the learning audible signal and target speech signal are subjected to Fourier transform in units of one frame to obtain respective frequency components X(l,k) and S(l,k), where i is the frame number, k is the frequency component number. The feature quantity f(l,k) is calculated from X(l,k). The feature quantities f(l,k) of the number of frames of the input learning audible signal are provided, and classified in the given number of clusters by clustering algorithm such as LBG algorithm. The centroid of each cluster is stored as a representative point, and used in clustering at the time of processing.

The weighting factor is obtained by setting a given evaluation function and optimizing the evaluation function for each cluster. The evaluation function of the following equation is defined by a sum of powers of errors each between a signal obtained by multiplying the amplitude of the learning audible signal X(l,k) classed in the i-th cluster Ci, for example, by the weight Wi(k) and the amplitude of the target speech signal S(l,k) corresponding to the result signal, and the weight Wi(k) making Ji(k) minimum is calculated.

$$Ji ( k ) = {\sum }_{l ∈ Ci} {( \vert X ( l , k ) \vert \times Wi ( k ) - \vert S ( l , k ) \vert )}^{2} \qquad ( 9 )$$

This is obtained by subjecting Ji(k) to partial differentiation by Wi(k) to make it zero as shown in the following equation (10).

$$Wi ( k ) = \frac{\sum \vert S ( l , k ) \vert \vert X ( l , k ) \vert}{\sum {\vert X ( l , k ) \vert}^{2}} \qquad ( 10 )$$

The weighting factors Wi(k) of the number of clusters are obtained for each frequency component k. In the evaluation function of the equation (9), all frames classed in the cluster Ci are treated with the same scale, but a different standard for each frame may be used. For example, the weighted sum of powers of errors can be the evaluation function as shown in the following equation (11).

$${Ji}^{′} ( k ) = {\sum }_{l ∈ Ci} A ( l , k ) {( \vert X ( l , k ) \vert \times Wi ( k ) - \vert S ( l , k ) \vert )}^{2} \qquad ( 11 )$$

By setting the weighting factor A(l,k) to a large value for a frame corresponding to a speech interval it is possible to control the weighting factor according to an object such as obtaining the weighting factor Wi(k) attached great importance to the speech interval.

In the present embodiment, the weighting factor is obtained for each frequency component k, but it can be obtained in units of a subband configured by a group of a plurality of frequency components. In that case, a method of expressing the evaluation function Q(p) of the p-th subband as the sum of distortions of frequency components k corresponding to the p-th subband by the following equation (12) is convenient.

$$Q ( p ) = {\sum }_{k ∈ Sp} Ji ( k ) \qquad ( 12 )$$

The weighting factor Wi(k) can be obtained by minimizing the evaluation function by the method similar to the above.

### Third Embodiment

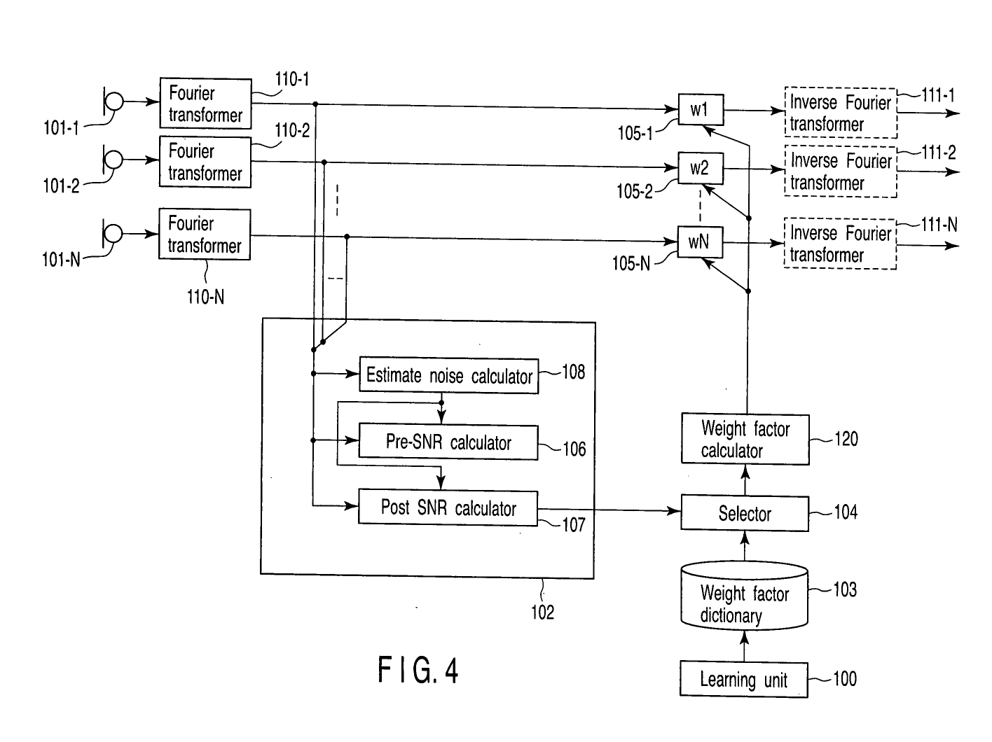

The third embodiment will be explained with reference to FIG. 4. The audible signal processing apparatus of FIG. 4 is similar to the second embodiment except that a weighting factor calculator 120 is added to the pre-stage of the weighting unit 105. Although the equation (6) determines directly the weighting factor from the feature quantity (ξ(n,k), γ(n,k)), but a parameter for determining the weighting factor is selected in the present embodiment. In other words, the weighting factor is determined using a function P{ } making a coefficient obtained by F( ) a parameter as shown in following equation (13).

G(n,k)=P{F(ξ(n,k),γ(n,k))} (13)

For example, in the spectrum subtraction described by S. F. Boll, “Suppression of Acoustic Noise in Speech Using Spectral Subtraction,” IEEE Trans. ASSP vol. 27, pp. 113-120, 1979, used as a noise suppression technique to be simple and easy well, the estimate value of amplitude of the target speech signal is expressed by the following equation (14).

|X′(n,f)|=|Y(n,f)|−βN(n,k) (14)

where N(n,k) is an amplification of an estimate noise and equal to sqrt(λd(n,k)). According to a general technique that the phase information of X′(n,f) uses the phase information of Y(n,f), the equation (14) can be transformed to the following equation (15).

$${X}^{′} ( n , f ) = \frac{( \vert Y ( n , f ) \vert - β N ( n , k ) )}{\vert Y ( n , f ) \vert} Y ( n , f ) \qquad ( 15 )$$

When expressing the right-hand side first item of the equation (15) by the following equation (16),

$$Gss ( n , k ) = \frac{( \vert Y ( n , f ) \vert - β N ( n , k ) )}{\vert Y ( n , f ) \vert} \qquad ( 16 )$$

the equation (15) is the following equation (17) and can be expressed by the same form as the equation (7).

X′(n,k)=Gss(n,k)Y(n,k) (17)

The parameter selected from the weighting factor dictionary 103 is assumed to be β. In other words, β=F(ξ(n,k), γ(n,k)) is selected from the weighting factor dictionary 103, and the function P( ) is defined by the following equation (18) and expresses the weighting factor Gss(n,k).

$$P \{ β \} = \frac{( \vert Y ( n , f ) \vert - β N ( n , k ) )}{\vert Y ( n , f ) \vert} \qquad ( 18 )$$

As thus described, estimate precision of a parameter at the time of learning can be improved by selecting a parameter of the weighting factor (β) without acquiring the weighting factor from the weighting factor dictionary 103 directly.

### Fourth Embodiment

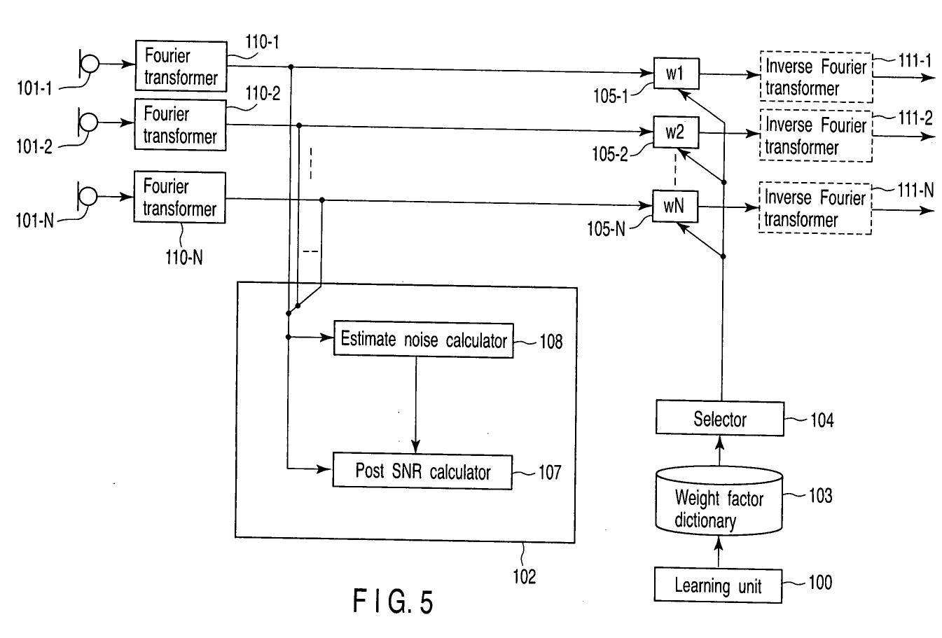

In the audible signal processing apparatus of the fourth embodiment, the pre-SNR calculator 106 is removed from the audible signal processing apparatus (FIG. 3) of the second embodiment as shown in FIG. 5. According to the present embodiment, there is an advantage in that the search speed of a representative point in the selector 104 becomes fast in comparison with the second embodiment, because the feature quantity input to the selector 104 is only the post SNR γ(l,k),

### Fifth Embodiment

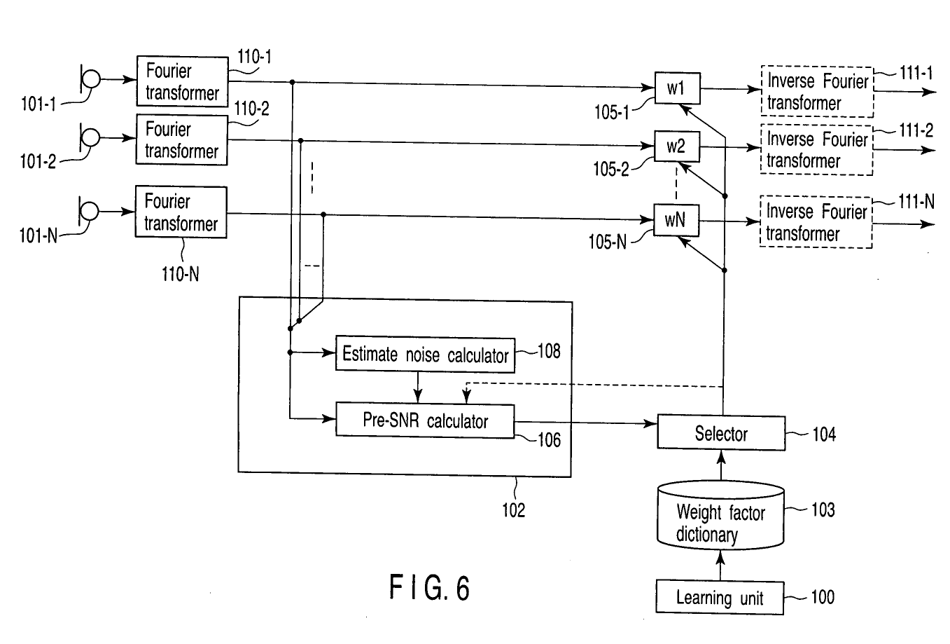

In the audible signal processing apparatus of the fourth embodiment, the post SNR calculator 107 is removed from the audible signal processing apparatus (FIG. 3) of the second embodiment as shown in FIG. 6. In the present embodiment, there is an advantage in that the search speed of a representative point in the selector 104 becomes fast in comparison with the second embodiment, because the feature quantity input to the selector 104 is only the pre-SNR y(l,k).

### Sixth Embodiment

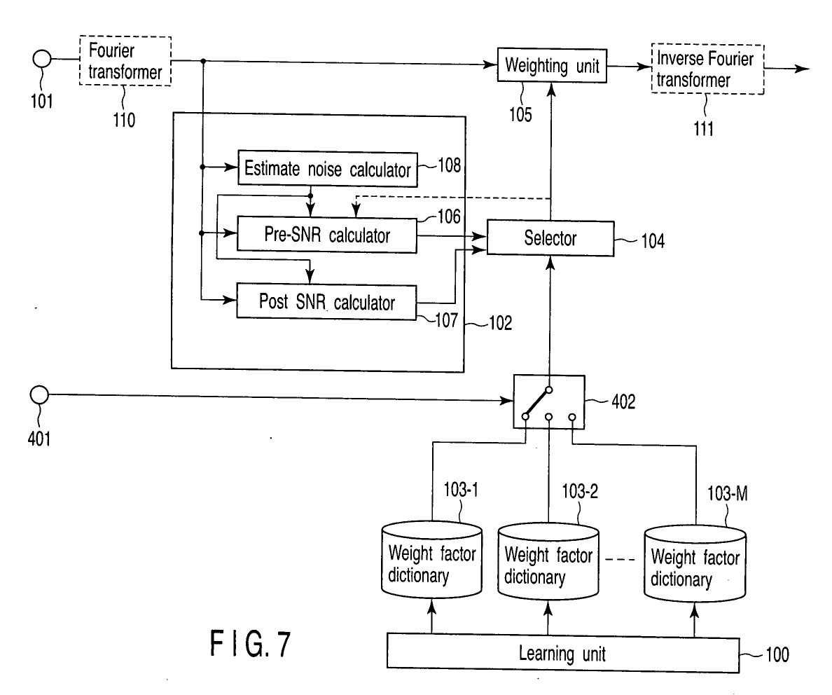

FIG. 7 shows an audible signal processing apparatus of the sixth embodiment, wherein a switch 402 switched by a control signal 401 is added to the audible signal processing apparatus of the second embodiment showed in FIG. 2, and further comprises a plurality of weighting factor dictionaries 103-1 to 103-M. For simply, FIG. 7 shows an example using one microphone 101, but a plurality of microphones may be used.

The operation of the present embodiment will be described hereinafter. The operation of the present embodiment is basically the same as the second embodiment, but a point changing the weighting factor dictionaries 103-1 to 103-M with the switch 402 differs from the second embodiment. One of M weighting factor dictionaries 103-1 to 103-M is selected by the switch 402 according to control signal 401. For example, when the audible signal processing apparatus is assumed to be used for a car, the weighting factor dictionaries 103-1 to 103-M are prepared corresponding to various kinds of speed of car, and changed according to the speed of car. This makes it possible to use an optimum weighting factor for each speed of car, resulting in enabling to realize higher noise suppression performance.

### Seventh Embodiment

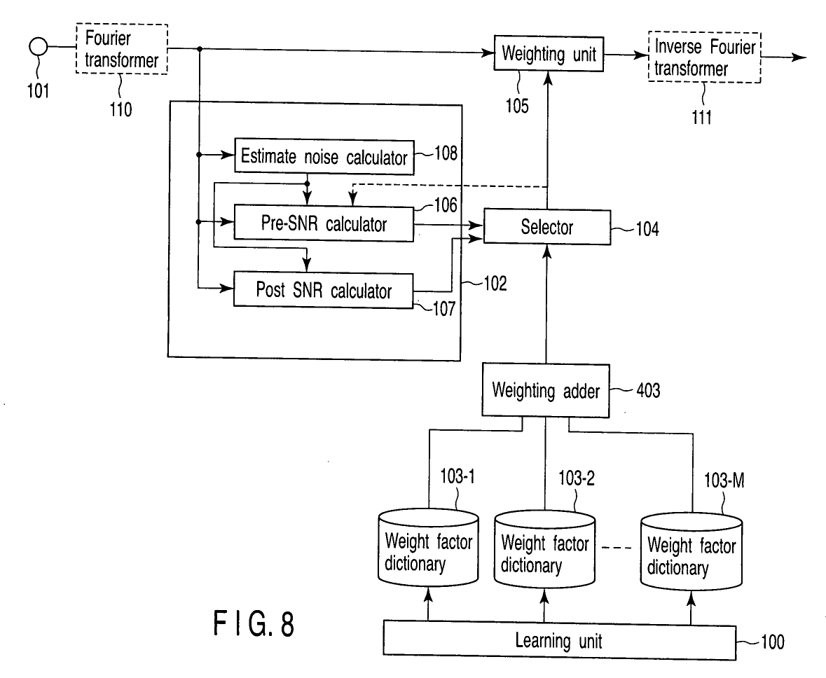

FIG. 8 illustrates an audible signal processing apparatus of the seventh embodiment, wherein the switch 402 of FIG. 7 is replaced with a weighting adder 403. The weighting adder 403 subjects the weighting factors output from all of a plurality of weighting factor dictionaries 103-1 to 103-M or the weighting factors selected from some of the weighting factor dictionaries 103-1 to 103-M to weighting addition, to smooth them. In the weighting adder 403, a fixed weighting factor may be used for the weighted addition, and a variable weighting factor controlled according to a control signal may be used.

### Eighth Embodiment

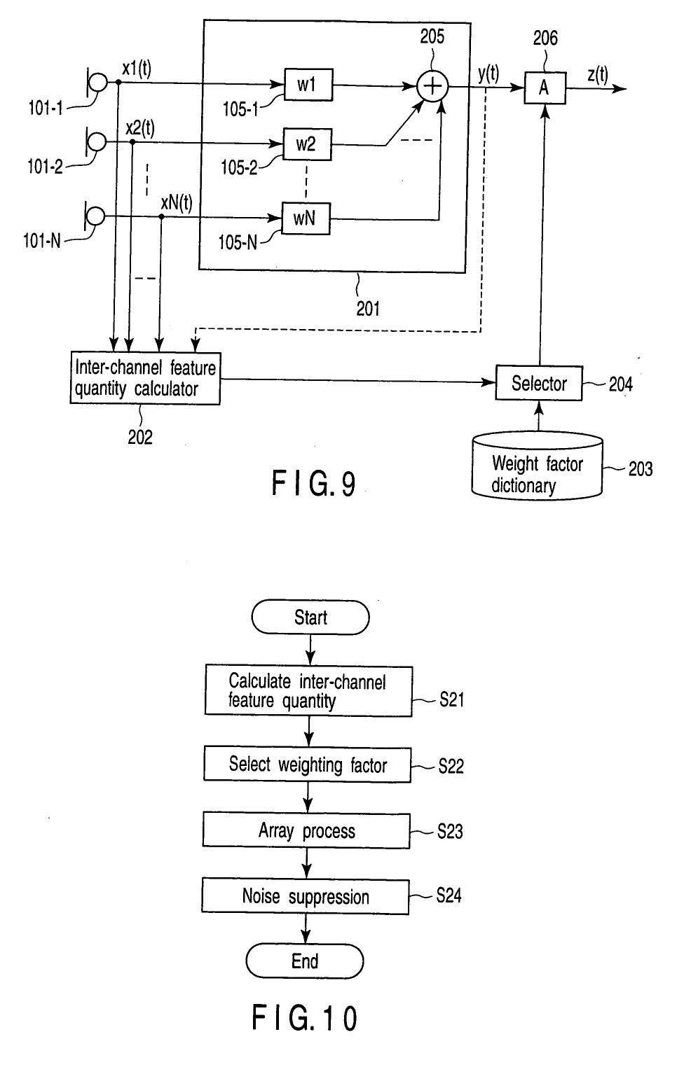

In the audible signal processing apparatus according to the eighth embodiment as shown in FIG. 9, input audible signals of N channels from a plurality of (N) microphones 101-1 to 101-N are input to an inter-channel feature quantity calculator 202 and weighting units 105-1 to 105-N of an array unit 201. The inter-channel feature quantity calculator 202 calculates a feature quantity (referred to as an inter-channel feature quantity herein) representing a difference between input audible signals of channels and send it to the selector 204. The selector 204 selects one weighting factor corresponding to the inter-channel feature quantity from the weighting factor dictionary 203 which stores a number of weighting factors.

On the other hand, the adder 205 adds the input audible signals weighted with the weighting units 105-1 to 105-N in the array unit 201 to integrate them and output an integrated audible signal from the array unit 201. The noise suppressor 206 weights the integrated audible signal by the weighting factor selected with the selector 204, to generate an output audible signal that a target speech signal (for example, a speech of a specific speaker) is emphasized.

The processing procedure of the present embodiment will be described according to a flow chart of FIG. 10. The inter-channel feature quantity calculator 202 calculates the inter-channel feature quantities from the input audible signals (x1 to xN) output from the microphones 101-1 to 101-N (step S11). When a digital signal processing technology is used, the input audible signals x1 to xN are digital signals digitized in a time direction with an analog-to-digital converter (not shown), and expressed by x(t) using a time index t, for example. If the input audible signals x1 to xN are digitized, the inter-channel feature quantities are digitized, too. Correlation coefficient of the input audible signals x1 to xN, cross spectrum, SNR (signal-to-noise ratio) can be used as a concrete example of the inter-channel feature quantity as described below.

Based on the inter-channel feature quantity calculated in step S21, the selector 204 selects a weighting factor corresponding to the inter-channel feature quantity from the weighting factor dictionary 203 (step S22). In other words, the weighting factor selected from the weighting factor dictionary 203 is taken out. Correspondence between the inter-channel feature quantity and weighting factor is determined beforehand. As a most simple and easy method there is a method of corresponding one-on-one the inter-channel feature quantity and weighting factors which are digitized. For a more effective corresponding method, there is a method of grouping the inter-channel feature quantities using a clustering method such as LBG and assigning a corresponding weighing factor to each group. A method of corresponding the weighting factors by a weighted sum of outputs of each distribution by using a statistical distribution such as GMM (Gaussian mixture model) is conceivable. As thus described, various methods about correspondence are conceivable and determined in consideration of computation cost or memory capacity of the memory. In this way, the weighting factor A selected with the selector 104 is set to a noise suppressor 206.

On the other hand, the input audible signals x1 to xN are sent to the weighting units 105-1 to 105-N of the array unit 201. The array unit 201 performs control of directivity by weighting addition to output an integrated audible signal (step S23). The integrated audible signal is weighted by the weighting factor A with the noise suppressor 206, whereby an output audible signal that a speech signal is emphasized is provided (step S24).

The inter-channel feature quantity calculator 202 will be described in detail hereinafter. The inter-channel feature quantity is a quantity representing a relation between the input audible signals x1 to xN of N channels from the N microphones 101-1 to 101-N as described before. Concretely, there is a correlation coefficient, a cross spectrum or SNR. If the input audible signals from two microphones are assumed to be x(t), y(t), the correlation coefficient is expressed by the following equation.

$$r = \frac{E \{ x ( n ) y ( n ) \}}{\sqrt{E \{ x 1 ( n ) x 1 ( n ) \}} \sqrt{E \{ x 2 ( n ) x 2 ( n ) \}}} \qquad ( 19 )$$

where E{ } denotes a time average. When the input audible signals are more than two channels, the correlation coefficient can be calculated by the following equation (20).

$$r = \frac{\sum pqE \{ xp ( n ) xq ( n ) \}}{\sum pq \sqrt{E \{ xp ( n ) xp ( n ) \}} \sqrt{( E \{ xq ( n ) xq ( n ) \}}} \qquad ( 20 )$$

where xp(n) and xq(n) are p-th and q-th input audible signals, respectively, and Σpq indicates a sum of all combinations aside from repetition of xp and xq. This correlation coefficient is expressed by the following equation (21) in frequency domain.

$$ρ = \sum f γ ( f ) \\ γ ( f ) = \frac{Wx 1 x 2 ( f )}{\sqrt{Wx 1 x 1 ( f ) Wx 2 x 2 ( f )}} \qquad ( 21 )$$

where f is a frequency component provided by discrete Fourier transform, Wx1x2(f) is a cross spectrum between input signals, Wx1x1(f), Wx2x2(f) are power spectra of input audible signals x1(n), x2(n), Σf expresses a sum for all frequency components.

The cross spectrum Wx1x2(f) and γ(f) obtained by normalizing this can be used as a feature quantity. A set of the cross spectrum Wx1x2(f) and power spectrum Wx1x1(f), Wx2x2(f) can configure a feature quantity as three-dimensional vector. Alternatively, a set of Wx1x1(f)+Wx2x2(f) expressing powers of all channels or a power spectrum Wyy(f) of an array output and a cross spectrum Wx1x2(f) can configure a feature quantity as a two-dimensional vector. Further, by detecting an interval during which there is no target speech signal, it is possible to use a power spectrum Wnn(f) during the interval as one of feature quantities, and use it for correction of another feature quantity (subtraction from a power spectrum).

Expression with frequency domain can be expanded larger than three channels by a method similar to the case of time domain. Also, it is possible to use a technique representing another correlation such as generalized cross correlation function. The generalized cross correlation function is described by, for example, “The Generalized Correlation Method for Estimation of Time Delay, C. H. Knapp and G. C. Carter, IEEE Trans, Acoust., Speech, Signal Processing”, vol. ASSP-24, No. 4, pp. 320-327 (1976).

SNR indicates a rate between the power S of the signal component and the power N of the noise component and is defined by SNR=S/N. Usually, SNR is used by being converted into a decibel value. N indicates an interval during which there is no target speech signal and can be measured. Because the power S cannot be observed directly, a method of using the input audible signal as it is, or a method of estimating the power S indirectly using a technique of Decision-Directed disclosed by Y. Ephraim, D. Malah, “Speech Enhancement Using a Minimum Mean-Square Error Short-Time Spectral Amplitude Estimator”, IEEE Trans. ASSP vol. 32, 1109-1121, 1984 is used. It is possible to use an average of SNRs for all channels or a sum thereof as the feature quantity other than a method of obtaining a SNR for each channel and using it as a feature quantity. Further, a method of combining SNRs provided by different calculation methods is preferable.

The array unit 201 will be described hereinafter.

In the present embodiment, the array unit 201 is not limited particularly, and any array is available. A delay sum array can be provided as a simple array. The delay sum array uses a method of adjusting array weighting factors W (making in-phase) so that a phase difference between signals in a target direction becomes 0 and adding them. W is a complex number, and is made in-phase by its declination.

A Griffiths-Jim type array, DCMP (Directionally Constrained Minimization of Power) or the smallest variance beamformer is famous as an example of an adaptation type array. In addition, in late years various methods such as techniques based on ICA (Independent Component Analysis) are proposed, and the target speech signal is emphasized using these methods.

A residual noise is included in the integrated audible signal that the target speech signal is emphasized. In particular, a diffuse noise cannot be suppressed enough by an array process doing noise suppression using space information. The noise suppressor 206 suppresses such a noise. Such a noise suppression process is referred to as a post-filter, and attracted attention as a part of the array process conventionally.

A method of obtaining a weighting factor based on a Wiener filter by analysis is mainstream conventionally. In contrast, the present embodiment realizes a noise suppression process by choice of the weighting factor based on the inter-channel feature quantity. Concretely, the noise suppression process is realized by selecting the weighting factor from the weighting factor dictionary 203 learned beforehand based on inter-channel feature quantity, and convoluting the selected weighting factor in the integrated audible signal in the noise suppressor 206 or in the case of a process in frequency domain, multiplying the selected weighting factor by the integrated audible signal in the noise suppressor 206.

By learning a weighting factor beforehand, using a tendency of the inter-channel feature quantity denoted by the noise component to be suppressed, high suppression performance can be attained under a noise environment similar to the environment at the time of learning. A measure for miniaturizing a square error between the above-mentioned target speech signal and the noise is used for learning.

### Ninth Embodiment

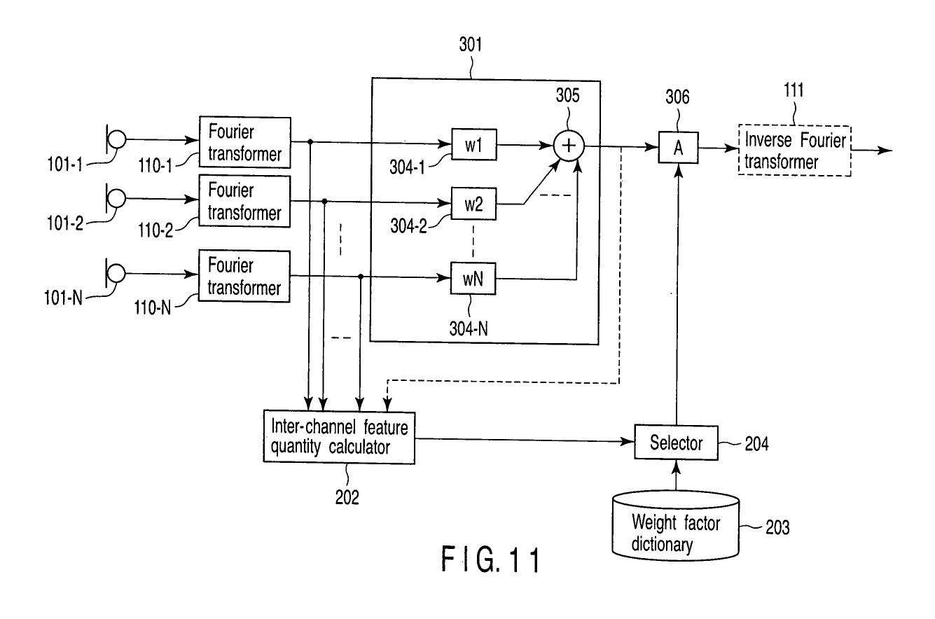

In an audible signal processing apparatus according to the ninth embodiment shown in FIG. 11, Fourier transformers 110-1 to 110-N and an inverse Fourier transformer 111 are added to the audible signal processing apparatus of FIG. 9 according to the eighth embodiment. The Fourier transformers 110-1 to 110-N transform input audible signals of N channels into signals of frequency domain, and the inverse Fourier transformer 111 transforms the audible signal of frequency domain, which was subjected to the array process and the noise suppression, into a signal of time domain.

With addition of the Fourier transformers 110-1 to 110-N and the inverse Fourier transformer 111, the array unit 201 having the weighting units 105-1 to 105-N and the adder 205, and the noise suppressor 206 are replaced for an array unit 301 having weighting units 304-1 to 304-N of frequency domain and an adder 305, and a noise suppressor 306. Convolution operation in time domain is expressed by operation of the product in frequency domain as is known in a field of digital signal processing technology.

In the present embodiment, input audible signals of N channels are transformed into signals of frequency domain by the Fourier transformers 110-1 to 110-N and then they are subjected to array process and noise suppression. The noise-suppressed signal is subjected to inverse Fourier transform to be transformed to the signal of time domain. Therefore, the present embodiment executes a process equivalent to the eighth embodiment doing a process of time domain. In this case, the output signal Y(k) from the adder 305 is expressed not by convolution shown by the equation (2) but in form of the product as expressed by the following equation (22).

$$Y ( k ) = {\sum }_{n = 1}^{N} xn ( k ) wn ( k ) \qquad ( 22 )$$

where k is a frequency index. Similarly, the operation of the noise suppressor 306 is expressed in form of the product according to the following equation (23), too.

Z(k)=Y(k)A(k) (23)

The output audible signal z(t) of time domain is obtained when the output signal Z(k) from the noise suppressor 306 is subjected to inverse Fourier transform by the inverse Fourier transformer 111. The output signal Z(k) of frequency domain from the noise suppressor 306 as it is can be used as a parameter of speech recognition, for example.

When the input audible signal is processed after transforming it into frequency domain as the present embodiment, the following advantage is obtained. In other words, computation cost may be reduced depending on a filter order of the array unit 301 and noise suppressor 306, and it is easy to cope with a complicated noise such as reverberation sound because the process can be done for each frequency band.

### Tenth Embodiment

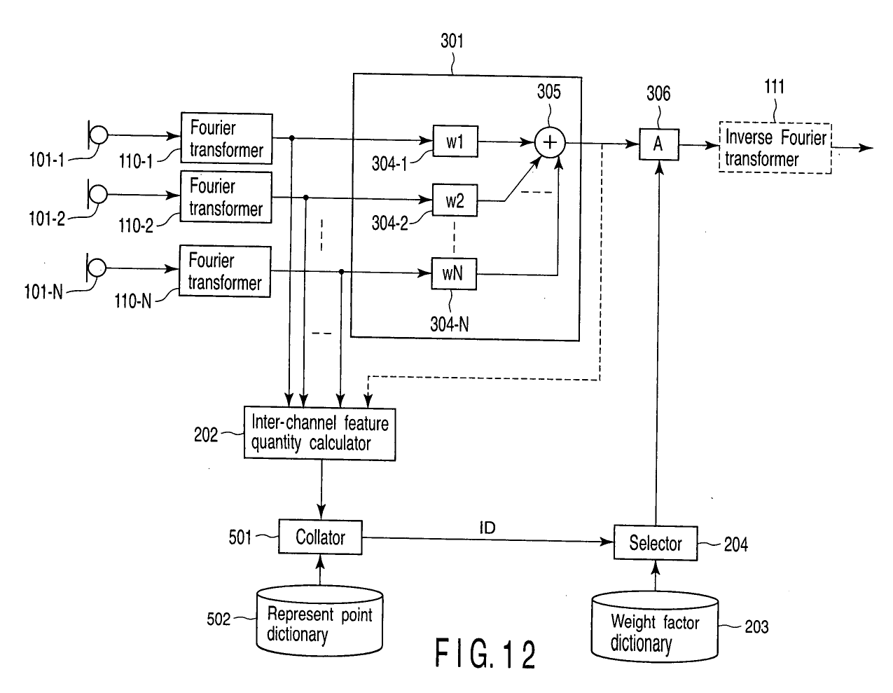

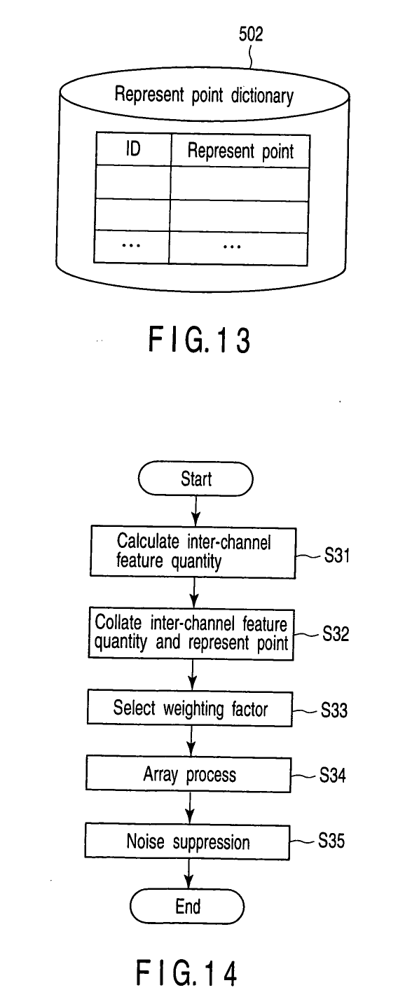

FIG. 12 shows an audible signal processing apparatus according to the tenth embodiment, which includes a collator 501 and a representative point dictionary 502 added to the audible signal processing apparatus of FIG. 11 according to the ninth embodiment. The representative point dictionary 502 stores feature quantities of a plurality of (I) representative points provided by a LBG method by corresponding to indexes ID as shown in FIG. 13. The representative point is a representative point of each cluster when clustering the inter-channel feature quantity.

The processing procedure of the audible signal processing apparatus of FIG. 12 is shown in the flowchart of FIG. 14. The process of the Fourier transformers 110-1 to 110-N and inverse Fourier transformer 111 is omitted in FIG. 14. The inter-channel feature quantity calculator 202 calculates inter-channel feature quantities of Fourier transformed audible signals of N channels (step S31).

The collator 501 collates the feature quantities of a plurality of (I) representative points stored in the representative point dictionary 502 with each inter-channel feature quantity, and calculates a distance there between (step S32). The index ID indicating the feature quantity of the representative point making the distance between the feature quantity of inter-channel feature quantity and the representative point smallest is sent to the selector 204 from the collator 501. The selector 204 selects the weighting factor corresponding to the index ID from the weighting factor dictionary 203 (step S33). The weighting factor selected with the selector 204 is set to the noise suppressor 306.

On the other hand, when the input audible signals transformed into frequency domain with the Fourier transformers 110-1 to 110-N are input to the weighting units 304-1 to 304-N of the array unit 301, an integrated audible signal is produced (step S34).

The noise suppressor 306 calculates the output signal that the noise of the integrated audible signal is suppressed according to the weighting factor set in step S33, whereby an output audible signal that a target speech signal is emphasized is produced (step S35). The inverse Fourier transformer 111 subjects the output audible signal from the noise suppressor 306 to inverse Fourier transform, to obtain an output audible signal of time domain.

### Eleventh Embodiment

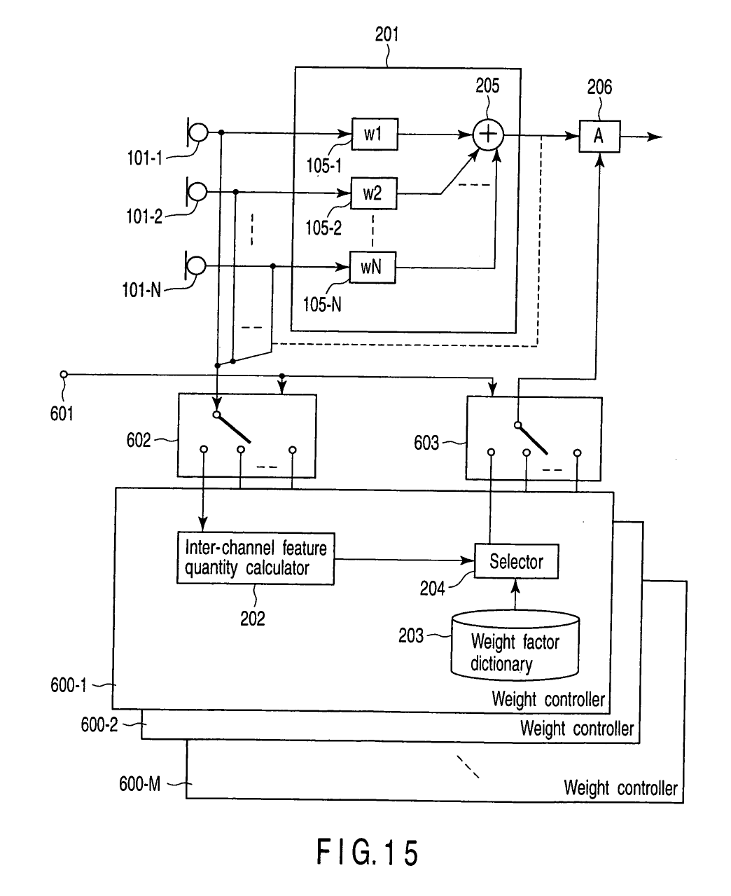

As shown in FIG. 15, an audible signal processing apparatus according to the eleventh embodiment provides with a plurality of (M) weight controllers 600-1 to 600-M each comprising the inter-channel feature quantity calculator 202, the weighting factor dictionary 203 and the selector 204 as explained in the ninth embodiment.

The weight controllers 600-1 to 600-M are changed with the input switch 602 and output switch 603 according to the control signal 601. In other words, a set of input audible signals of N channels from the microphone 101-1 to 101-N are input to any of the weight controllers 600-1 to 600-M with the input switch 602. The inter-channel feature quantity calculator 202 calculates an inter-channel feature quantity.

In the weight controller to which the set of input audible signals are input, the selector 204 selects the weighting factor corresponding to the inter-channel feature quantity from the weighting factor dictionary 203. The selected weighting factor is given to the noise suppressor 206 through the output switch 603.

On the other hand, the adder 205 adds the audible signals of N channels from the weighting units 105-1 to 105-N. As a result, the array unit 201 outputs an addition result as an integrated audible signal. The noise suppressor 206 subjects the integrated audible signal to noise suppression using the weighting factor selected with the selector 204, whereby an output audible signal that a target speech signal is emphasized is generated.

The weighting factor dictionary 203 is prepared beforehand by learning in the acoustic environment which is almost actual use environment. Practically, various kinds of acoustic environment are assumed. For example, in-car acoustic environment is different by the model of a car greatly. The weighting factor dictionary 203 in each of the weight controllers 600-1 to 600-M are learned under different acoustic environments respectively. Therefore, when the weight controllers 600-1 to 600-M are switched according to the actual use environment at the time of processing the audible signal, and weighting is done by using the weighting factor selected by the selector 204 from the weighting factor dictionary 203 learned under the acoustic environment identical to the actual use environment or most similar thereto, audible signal processing suitable for true use environment can be carried out.

The control signal 601 used for switching the weight controllers 600-1 to 600-M may be generated by a button operation of a user, for example, and may be generated automatically using a parameter due to the input audible signal such as a signal-to-noise ratio (SNR). Also, it may be generated using a parameter from the outside such as speed of car as an index.

When the inter-channel feature quantity calculator 202 is provided in each of the weight controllers 600-1 to 600-M, it is expected to calculate the more precise inter-channel feature quantity by use of a calculation method suitable for acoustic environment corresponding to each of the weight controllers 600-1 to 600-M, and a parameter for the same.

The audible signal process based on the embodiment described above can be realized by hardware, but can carry out by software using a computer such as a personal computer. The present invention can provide a computer readable storage medium storing a program for executing the audible signal process.

According to the present invention, the weighting factor can be obtained only by referring a learning result without doing complicated calculation in order to obtain the weighting factor by learning. Since a characteristic of a signal can reflect in direct the weighting factor without a statistical model, when a statistical property of speech and noise to be processed is different from the statistical model, it is possible to realize a higher noise suppression effect than the technique to use a statistical model of MMSE.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An audible signal process method comprising:
preparing, in at least one dictionary, a plurality of weighting factors each learned to optimize an evaluation function and used for weighting, the evaluation function being established by a weighted learning audible signal and a target speech signal corresponding to the learning audible signal;
estimating a noise component included in an input audible signal based on the input audible signal;
calculating a feature quantity depending upon the estimated noise component;
selecting a weighting factor corresponding to the feature quantity from the dictionary; and
weighting the input audible signal using the selected weighting factor to generate an output audible signal.

2. The method according to claim 1, wherein the evaluation function is obtained by a sum of errors between the learning audible signal and the target speech signal, and the evaluation function is optimized by minimization of the sum.

3. The method according to claim 1, wherein the selecting includes calculating a distance between the feature quantity and a plurality of representative points prepared beforehand, determining a representative point making the distance with respect to the feature quantity small relatively, and selecting the weighting factor corresponding to the determined representative point from the dictionary.

4. The method according to claim 1, wherein the weighting includes transforming the selected weighting factor into a predetermined function, and weighting the input audible signal using the transformed weighting factor.

5. The method according to claim 1, wherein the calculating includes calculating a signal-to-noise ratio between a signal component and a noise component which are included in the input audible signal.

6. The method according to claim 1, wherein the calculating includes calculating an estimation of a signal-to-noise ratio between a signal obtained by removing a noise component from the input audible signal and the noise component.

7. The method according to claim 1, further including selecting a dictionary from a plurality of weighting factor dictionaries by switching the plurality of dictionaries according to an acoustic environment.

8. The method according to claim 1, wherein the weighting factor corresponds to a filter coefficient of time domain, and the weighting includes weighting the input audible signal by convolution of the input audible signal and the selected weighting factor.

9. The method according to claim 1, wherein the weighting factor corresponds to a filter coefficient of frequency domain, and the weighting includes weighting the input audible signal by product of the input audible signal and the selected weighting factor.

10. An audible signal process apparatus comprising:
a dictionary to store a plurality of weighting factors each learned to optimize an evaluation function used for weighting, the evaluation function being established by a weighted learning audible signal and a target speech signal corresponding to the learning audible signal;
an estimator to estimate a noise component included in the input audible signal based on the input audible signal;
a calculator to calculate a feature quantity depending upon the noise component of the input audible signal;
a selector to select a weighting factor corresponding to the feature quantity from the dictionary; and
a weighting unit configured to weight the input audible signal using the selected weighting factor to generate a processed output audible signal.

11. An audible signal process method comprising:
calculating at least one feature quantity representing a correlation between input audible signals of plural channels;
selecting a weighting factor obtained beforehand by learning from at least one dictionary according to the feature quantity;
generating an integrated audio signal by subjecting the input audible signals of plural channels to processing including weighting addition; and
weighting the integrated audible signal using the weighting factor to generate a processed output audible signal.

12. The method according to claim 11, wherein the weighting factor is corresponded to the feature quantity beforehand.

13. The method according to claim 11, wherein the selecting includes calculating a distance between the feature quantity and a plurality of feature quantities prepared beforehand, and determine a representative point making the distance with respect to the prepared feature quantity small relatively, and the weighting factor is corresponded to the representative point beforehand.

14. The method according to claim 11, wherein the calculating includes a coefficient of correlation between the input audible signals of channels.

15. The method according to claim 11, wherein the calculating includes calculating a cross spectrum between the input audible signals of channels.

16. The method according to claim 11, wherein the calculating includes calculating a signal-to-noise ratio of the input audible signal.

17. The method according to claim 11, wherein the weighting factor is obtained by a filter coefficient of time domain, and the weighting is done by convolution of the integrated audible signal and the weighting factor.

18. The method according to claim 11, wherein the weighting factor is obtained by a filter coefficient of frequency domain, and the weighting is done by product of the integrated audible signal and the weighting factor.

19. The method according to claim 11, further including selecting a dictionary from a plurality of dictionaries according to an acoustic environment.

20. An audible signal process apparatus comprising:
a calculator to calculate at least one feature quantity representing a correlation between input audible signals of channels;
a selector to select a weighting factor obtained beforehand by learning from at least one dictionary according to the feature quantity;
a signal processor to generate an integrated audio signal by subjecting the input audible signals of channels to processing including weighting addition; and
a weighting unit configured to weight the integrated audible signal using the weighting factor to generate a processed output audible signal.

21. A computer readable storage medium storing instructions of a computer program which when executed by a computer results in performance of steps comprising:
preparing, in at least one dictionary, a plurality of weighting factors each learned to optimize evaluation function used for weighting, the evaluation function being established by an weighted learning audible signal and a target speech signal corresponding to the learning audible signal and;
estimating a noise component included in the input audible signal based on the input audible signal;
calculating a feature quantity depending upon the noise component of the input audible signal;
selecting a weighting factor corresponding to the feature quantity from the dictionary; and
weighting the input audible signal using the selected weighting factor to generate a processed output audible signal.

22. A computer readable storage medium storing instructions of a computer program which when executed by a computer results in performance of steps comprising:
calculating at least one feature quantity representing a correlation between input audible signals of plural channels;
selecting a weighting factor obtained beforehand by learning from at least one dictionary according to the feature quantity;
generating an integrated audio signal by subjecting the input audible signals of channels to processing including weighting addition; and
weighting the integrated audible signal using the weighting factor to generate a processed output audible signal.
